(19) United States
(12) Patent Application Publication
(10) Pub. No.: US 2006/0159176 A1
(43) Pub. Date: Jul. 20, 2006

(54) Method and apparatus for deriving motion vectors of macroblocks from motion vectors of pictures of base layer when encoding/decoding video signal

(76) Inventors: Seung Wook Park, Seoul (KR); Ji Ho Park, Seoul (KR); Byeong Moon Jeon, Seoul (KR)

Correspondence Address: HARNESS, DICKEY & PIERCE, P.L.C., P.O. BOX 8910, RESTON, VA, 20195, US

(21) Appl. No.: 11/300,417

(22) Filed: Dec. 15, 2005

Related U.S. Application Data
(60) Provisional application No. 60/636,097, filed on Dec. 16, 2004.

(30) Foreign Application Priority Data
Jun. 10, 2005 (KR) 10-2005-0049852

(51) Int. Cl. H04N 11/02; H04N 11/04; H04N 7/12; H04B 1/66

(52) U.S. Cl. 375/240.16; 375/240.24

(57) ABSTRACT

During scalable MCTF encoding of a video signal divided into base and enhanced layers, a first derivative vector of a first motion vector, obtained through motion estimation, of an image block in an arbitrary frame in the enhanced layer is obtained based on the product of a derivation factor and a scaled one of a motion vector of a first block in a base layer frame not temporally coincident with the arbitrary frame. A second derivative vector of a second motion vector, obtained through motion estimation, of the image block is obtained based on the scaled vector and the first motion vector. Information allowing bidirectional motion vectors of the image block to be obtained from the derivative vectors is recorded in motion vector information of the image block. Using the correlation between motion vectors of temporally adjacent frames in different layers reduces the amount of coded motion vector data.

### PRIORITY INFORMATION

This application claims priority under 35 U.S.C. §119 on Korean Patent Application No.10-2005-0049852, filed on Jun. 10, 2005, the entire contents of which are hereby incorporated by reference.

This application also claims priority under 35 U.S.C. §119 on U.S. Provisional Application No. 60/636,097, filed on Dec. 16, 2004; the entire contents of which are hereby incorporated by reference.

### BACKGROUND OF THE INVENTION

1. Field of the Invention

The present invention relates to scalable encoding and decoding of video signals, and more particularly to a method and apparatus for encoding a video signal in a scalable Motion Compensated Temporal Filtering (MCTF) scheme using motion vectors of pictures of a base layer and a method and apparatus for decoding such encoded video data.

2. Description of the Related Art

It is difficult to allocate high bandwidth, required for TV signals, to digital video signals wirelessly transmitted and received by mobile phones and notebook computers, which are widely used, and by mobile TVs and handheld PCs, which it is believed will come into widespread use in the future. Thus, video compression standards for use with mobile devices must have high video signal compression efficiencies.

Such mobile devices have a variety of processing and presentation capabilities so that a variety of compressed video data forms must be prepared. This indicates that the same video source must be provided in a variety of forms corresponding to a variety of combinations of a number of variables such as the number of frames transmitted per second, resolution, and the number of bits per pixel. This imposes a great burden on content providers.

Because of these facts, content providers prepare high-bitrate compressed video data for each source video and perform, when receiving a request from a mobile device, a process of decoding compressed video and encoding it back into video data suited to the video processing capabilities of the mobile device before providing the requested video to the, mobile device. However, this method entails a transcoding procedure including decoding and encoding processes, which causes some time delay in providing the requested data to the mobile device. The transcoding procedure also requires complex hardware and algorithms to cope with the wide variety of target encoding formats.

The Scalable Video Codec (SVC) has been developed in an attempt to overcome these problems. This scheme encodes video into a sequence of pictures with the highest image quality while ensuring that part of the encoded picture sequence (specifically, a partial sequence of frames intermittently selected from the total sequence of frames) can be decoded and used to represent the video with a low image quality. Motion Compensated Temporal Filtering (MCTF) is an encoding scheme that has been suggested for use in the scalable video codec.

Although it is possible to represent low image-quality video by receiving and processing part of the sequence of pictures encoded in the scalable MCTF coding scheme as described above, there is still a problem in that the image quality is significantly reduced if the bitrate is lowered. One solution to this problem is to provide an auxiliary picture sequence for low bitrates, for example, a sequence of pictures that have a small screen size and/or a low frame rate.

The auxiliary picture sequence is referred to as a base layer, and the main frame sequence is referred to as an enhanced or enhancement layer. Video signals of the base and enhanced layers have redundancy since the same video signal source is encoded into two layers. To increase the coding efficiency of the enhanced layer according to the MCTF scheme, one method converts each video frame of the enhanced layer into a predictive image based on a video frame of the base layer temporally coincident with the enhanced layer video frame. Another method codes motion vectors of a picture in the enhanced layer using motion vectors of a picture in the base layer temporally coincident with the enhanced layer picture. FIG. 1 illustrates how a picture in the enhanced layer is coded using motion vectors of a temporally coincident picture in the base layer.

The motion vector coding method illustrated in FIG. 1 is performed in the following manner. If the screen size of frames in the base layer is less than the screen size of frames in the enhanced layer, a base layer frame F1 temporally coincident with a current enhanced layer frame F10, which is to be converted into a predictive image, is enlarged to the same size as the enhanced layer frame. Here, motion vectors of macroblocks in the base layer frame are also scaled up by the same ratio as the enlargement ratio of the base layer frame.

A motion vector mv1 of each macroblock MB10 in the enhanced layer frame F10 is determined through motion estimation. The motion vector mv1 is compared with a scaled motion vector mvScaledBL1 obtained by scaling up a motion vector mvBL1 of a corresponding macroblock MB1 in the base layer frame F1, which covers an area in the base layer frame F1 corresponding to the macroblock MB10. If both the enhanced and base layers use macroblocks of the same size (for example, 16×16 macroblocks), a macroblock in the base layer covers a larger area in a frame than a macroblock in the enhanced layer. The motion vector mvBL1 of the corresponding macroblock MB1 in the base layer frame F1 is determined by a base layer encoder before the enhanced layer is encoded.

If the two motion vectors mv1 and mvScaledBL1 are identical, a value indicating that the motion vector mv1 of the macroblock MB10 is identical to the scaled motion vector mvScaledBL1 of the corresponding block MB1 in the base layer is recorded in a block mode of the macroblock MB10. If the two motion vectors mv1 and mvScaledBL1 are different, the difference between the two motion vectors mv1 and mvScaledBL1 is coded, provided that coding of the vector difference (i.e., mv1-mvScaledBL1) is advantageous over coding of the motion vector mv1. This reduces the amount of vector data to be coded in the enhanced layer coding procedure.

On the other hand, if the base and enhanced layers are encoded at different frame rates, some frames in the enhanced layer may have no temporally coincident frames in the base layer. For example, an enhanced layer frame (Frame B) shown in FIG. 1 has no temporally coincident frame in the base layer. The above methods for increasing the coding efficiency of the enhanced layer cannot be applied to the frame (Frame B) since it has no temporally coincident frame in the base layer.

However, enhanced and base layer frames, which have a short time interval therebetween although they are not temporally coincident, will be likely to be correlated with each other in the motion estimation since they are temporally close to each other. This indicates that, even for enhanced layer frames having no temporally coincident base layer frames, it is possible to increase the coding efficiency using motion vectors of base layer frames temporally close to the enhanced layer frames since the temporally close enhanced and base layer frames are likely to have similar motion vectors.

### SUMMARY OF THE INVENTION

Therefore, the present invention has been made in view of the above problems, and it is an object of the present invention to provide a method and apparatus for encoding video signals in a scalable scheme using motion vectors of base layer pictures temporally separated from pictures which are to be encoded into predictive images.

It is another object of the present invention to provide a method and apparatus for decoding pictures in a data stream of the enhanced layer, which have image blocks encoded using motion vectors of base layer pictures temporally separated from the enhanced layer pictures.

It is yet another object of the present invention to provide a method and apparatus for deriving motion vectors of a predictive image from motion vectors of the base layer when encoding a video signal into the predictive image or when decoding the predictive image into the video signal in a scalable scheme.

In accordance with the present invention, the above and other objects can be accomplished by the provision of a method and apparatus for encoding/decoding a video signal, wherein the video signal is encoded in a scalable MCTF scheme to output a bitstream of a first layer while the video signal is encoded in another specified scheme to output a bitstream of a second layer, and, when encoding is performed in the MCTF scheme, a first derivative vector corresponding to a first motion vector, obtained through motion estimation, of an image block included in an arbitrary frame in the video signal is obtained based on the product of a derivation factor and a scaled motion vector obtained by scaling a motion vector of a first block included in a frame of the second layer not temporally coincident with the arbitrary frame, a second derivative vector corresponding to a second motion vector, obtained through motion estimation, of the image block is obtained based on both the scaled motion vector and the first motion vector, and information allowing the motion vectors of the image block to be obtained from the first and second derivative vectors is recorded in the bitstream of the first layer.

In an embodiment of the present invention, information regarding motion vectors of an image block in an arbitrary frame present in the first layer is recorded using a motion vector of a block present in a frame in the second layer having a predictive image and being temporally closest to the arbitrary frame of the first layer.

In an embodiment of the present invention, the information regarding the motion vectors of the current image block is recorded using information indicating that motion vectors of the current image block are identical to vectors derived from a motion vector of a block in a frame in the second layer.

In another embodiment of the present invention, the information regarding the motion vectors of the current image block is recorded using respective difference vectors between the first and second derivative vectors and the first and second motion vectors which are actual motion vectors from the current image block to its reference blocks.

In an embodiment of the present invention, the screen size of frames of the second layer is less than the screen size of frames of the first layer.

In an embodiment of the present invention, the scaled motion vector is obtained by scaling the motion vector of the first block by half of the ratio (i.e., by the resolution ratio) of a frame size of the first layer to a frame size of the second layer.

In an embodiment of the present invention, a derivative vector corresponding to one of the first and second motion vectors, which is a forward vector, is obtained based on a vector obtained by multiplying the scaled motion vector, which is obtained by scaling the motion vector of the first block by half of the ratio (i.e., by the resolution ratio) of the frame size of the first layer to the frame size of the second layer, by the derivation factor.

In another embodiment of the present invention, a derivative vector corresponding to one of the first and second motion vectors, which is a backward vector, is obtained based on a vector obtained by multiplying the scaled motion vector, which is obtained by scaling the motion vector of the first block by half of the ratio (i.e., by the resolution ratio) of the frame size of the first layer to the frame size of the second layer, by the derivation factor.

In an embodiment of the present invention, the second derivative vector is obtained by adding the first motion vector to the scaled motion vector of the first block after adding either a positive sign (+) or a negative sign (−), appropriately selected according to a target derivative vector direction of the second derivative vector, to the scaled motion vector (i.e., after multiplying the scaled motion vector by −1 or +1 depending on the target derivative vector direction).

In the embodiments, the derivation factor is defined as the ratio of a time interval between the arbitrary frame and a frame, present downstream of the arbitrary frame in a target derivative vector direction of the image block, to a time interval between the frame in the second layer and another frame including a block pointed to by the motion vector of the first block.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates how a picture in the enhanced layer is coded using motion vectors of a temporally coincident picture in the base layer;

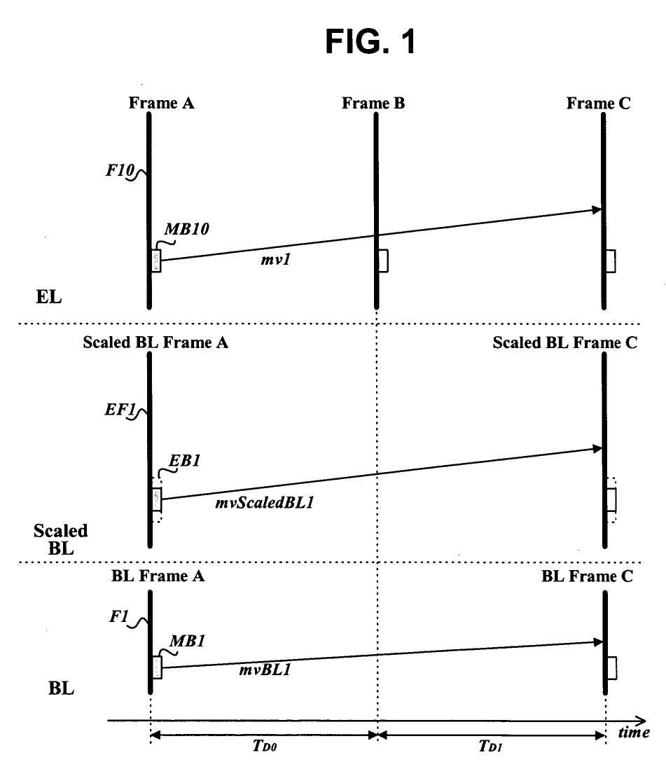

FIG. 2 is a block diagram of a video signal encoding apparatus to which a video signal coding method according to the present invention is applied;

FIG. 3 is a block diagram of part of a filter responsible for performing image estimation/prediction and update operations in an MCTF encoder of FIG. 2;

FIGS. 4a and 4b illustrate how a motion vector of a target macroblock in an enhanced layer frame to be coded into a predictive image is determined using a motion vector of a base layer frame temporally separated from the enhanced layer frame according to the present invention;

FIG. 5 is a block diagram of an apparatus for decoding a data stream encoded by the apparatus of FIG. 2; and

FIG. 6 is a block diagram of part of an inverse filter responsible for performing inverse prediction and update operations in an MCTF decoder of FIG. 5.

### DESCRIPTION OF THE PREFERRED EMBODIMENTS

Preferred embodiments of the present invention will now be described in detail with reference to the accompanying drawings.

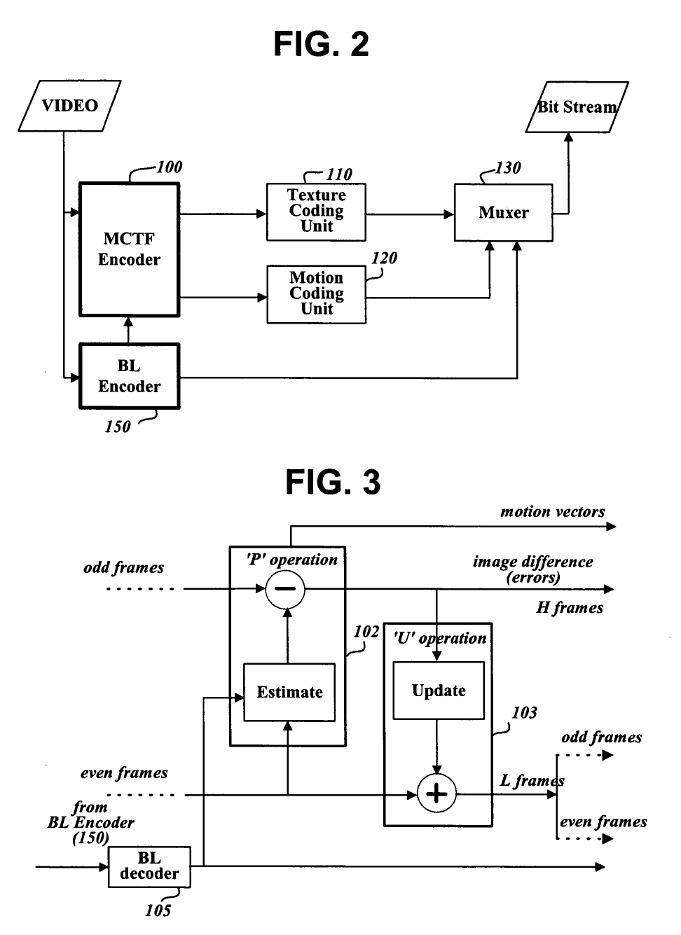

FIG. 2 is a block diagram of a video signal encoding apparatus to which a scalable video signal coding method according to the present invention is applied.

The video signal encoding apparatus shown in FIG. 2 comprises an MCTF encoder 100, a texture coding unit 110, a motion coding unit 120, a base layer encoder 150, and a muxer (or multiplexer) 130. The MCTF encoder 100 encodes an input video signal in units of macroblocks in an MCTF scheme, and generates suitable management information. The texture coding unit 110 converts information of encoded macroblocks into a compressed bitstream. The motion coding unit 120 codes motion vectors of image blocks obtained by the MCTF encoder 100 into a compressed bitstream according to a specified scheme. The base layer encoder 150 encodes an input video signal according to a specified scheme, for example, according to the MPEG-1, 2 or 4 standard or the H.261, H.263 or H.264 standard, and produces a small-screen picture sequence, for example, a sequence of pictures scaled down to 25% of their original size (with half of the original resolution). The muxer 130 encapsulates the output data of the texture coding unit 110, the picture sequence output from the base layer encoder 150, and the output vector data of the motion coding unit 120 into a predetermined format. The muxer 130 then multiplexes and outputs the encapsulated data into a predetermined transmission format. The base layer encoder 150 can provide a low-bitrate data stream not only by encoding an input video signal into a sequence of pictures having a smaller screen size than pictures of the enhanced layer but also by encoding an input video signal into a sequence of pictures having the same screen size as pictures of the enhanced layer at a lower frame rate than the enhanced layer. In the embodiments of the present invention described below, the base layer is encoded into a small-screen picture sequence.

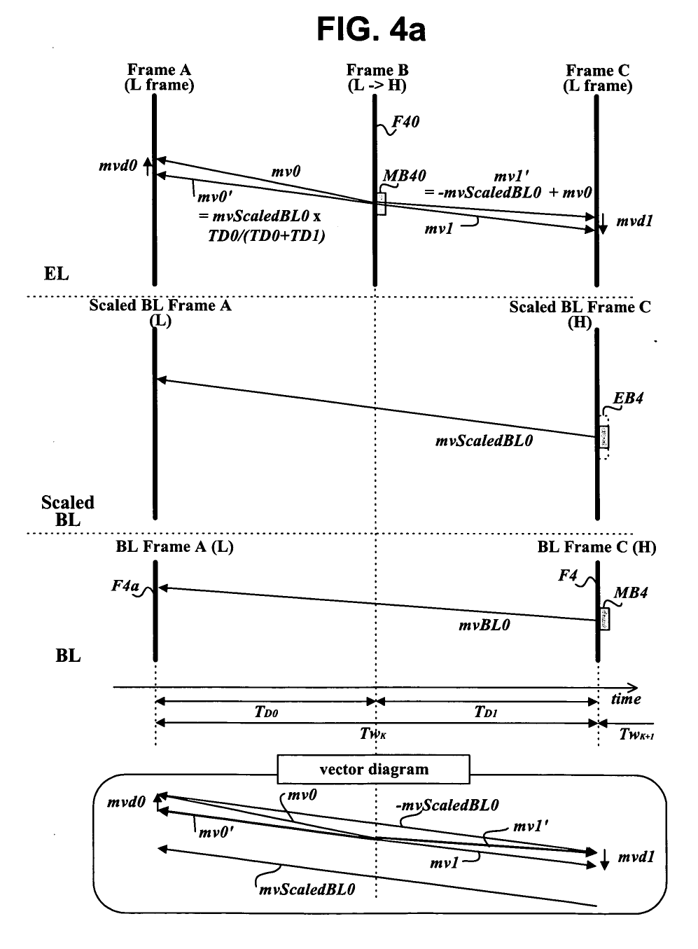

The MCTF encoder 100 performs motion estimation and prediction operations on each target macroblock in a video frame. The MCTF encoder 100 also performs an update operation on each target macroblock by adding an image difference of the target macroblock from a corresponding macroblock in a neighbor frame to the corresponding macroblock in the neighbor frame. FIG. 3 is a block diagram of main elements of a filter that performs these operations.

The MCTF encoder 100 separates an input video frame sequence into odd and even frames and then performs estimation/prediction and update operations on a certain-length sequence of pictures, for example, on a Group Of Pictures (GOP), a plurality of times until the number of L frames, which are produced by the update operation, is reduced to one. FIG. 3 shows elements associated with estimation/prediction and update operations at one of a plurality of MCTF levels.

The elements of FIG. 3 include an estimator/predictor 102, an updater 103, and a base layer (BL) decoder 105. The BL decoder 105 functions to extract a motion vector of each motion-estimated (inter-frame mode) macroblock from a stream encoded by the base layer encoder 150 and also to scale up the motion vector of each motion-estimated macroblock by the upsampling ratio required to reconstruct the sequence of small-screen pictures into their original image size. Through motion estimation, the estimator/predictor 102 searches for a reference block of each target macroblock of a current frame, which is to be coded to residual data, in a neighbor frame prior to or subsequent to the current frame, and codes an image difference (i.e., a pixel-to-pixel difference) of the target macroblock from the reference block. The estimator/predictor 102 directly calculates a motion vector of the target macroblock with respect to the reference block or generates information which uses a motion vector of a corresponding block scaled by the BL decoder 105. The updater 103 performs an update operation on a macroblock, whose reference block has been found by the motion estimation, by multiplying the image difference of the macroblock by an appropriate constant (for example, ½ or ¼) and adding the resulting value to the reference block. The operation carried out by the updater 103 is referred to as a ‘U’ operation, and a frame produced by the ‘U’ operation is referred to as an ‘L’ frame. Here, the function to scale the motion vector of the motion-estimated macroblock can be implemented as a separate unit from the BL decoder 105.

The estimator/predictor 102 and the updater 103 of FIG. 3 may perform their operations on a plurality of slices, which are produced by dividing a single frame, simultaneously and in parallel instead of performing their operations on the video frame. A frame (or slice) having an image difference (i.e., a predictive image), which is produced by the estimator/predictor 102, is referred to as an ‘H’ frame (or slice) since the difference value data in the ‘H’ frame (or slice) reflects high frequency components of the video signal. In the following description of the embodiments, the term ‘frame’ is used in a broad sense to include a ‘slice’, provided that replacement of the term ‘frame’ with the term ‘slice’ is technically equivalent.

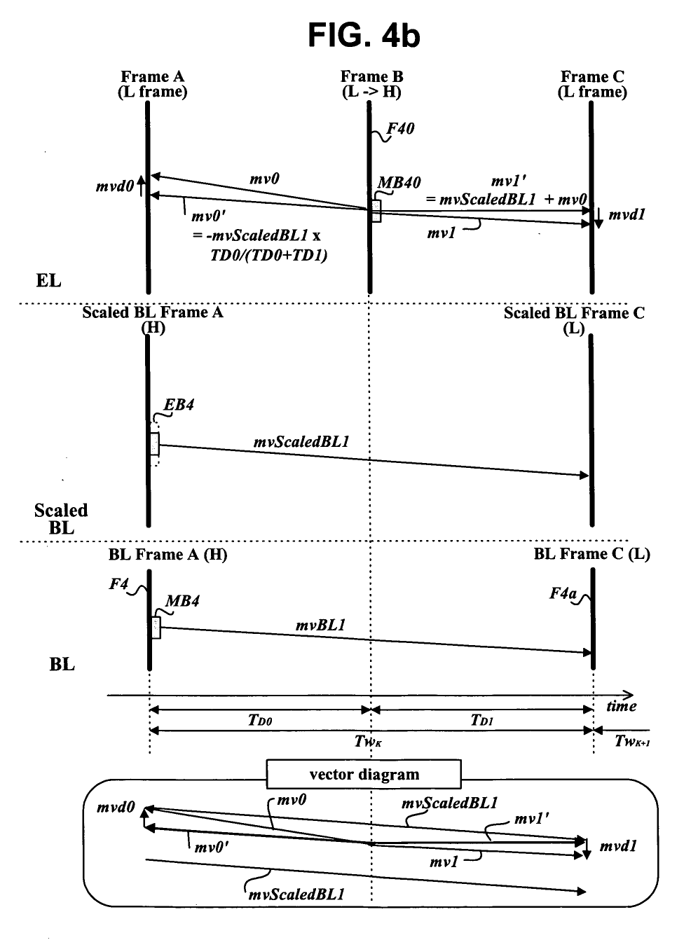

More specifically, the estimator/predictor 102 divides each of the input video frames (or each L frame obtained at the previous level) into macroblocks of a predetermined size. The estimator/predictor 102 codes each target macroblock of an input video frame through inter-frame motion estimation. The estimator/predictor 102 directly determines a motion vector of the target macroblock with respect to the reference block. Alternatively, if a temporally coincident frame is present in the enlarged base layer frames received from the BL decoder 105, the estimator/predictor 102 records, in an appropriate header area, information which allows the motion vector of the target macroblock to be determined using a motion vector of a corresponding block in the temporally coincident base layer frame. A detailed description of this procedure is omitted since it is known in the art and is not directly related to the present invention. Instead, example procedures for determining motion vectors of macroblocks in an enhanced layer frame using motion vectors of a base layer frame temporally separated from the enhanced layer frame according to the present invention will now be described in detail with reference to FIGS. 4a and 4b.

In the example of FIG. 4a, a frame (Frame B) F40 is a current frame to be encoded into a predictive image frame (H frame), and a base layer frame (Frame C) is a coded predictive frame in a frame sequence of the base layer. If a frame temporally coincident with the current enhanced layer frame F40, which is to be converted into a predictive image, is not present in the frame sequence of the base layer, the estimator/predictor 102 searches for a predictive frame (i.e., Frame C) in the base layer, which is temporally closest to the current frame F40. Specifically, the estimator/predictor 102 searches for information regarding the predictive frame (Frame C) in encoding information received from the BL decoder 105.

In addition, for a target macroblock MB40 in the current frame F40 which is to be converted into a predictive image, the estimator/predictor 102 performs motion estimation to find a macroblock most highly correlated with the target macroblock MB40 in adjacent frames prior to and/or subsequent to the current frame, and codes an image difference of the target macroblock MB40 from the found macroblock. Such an operation of the estimator/predictor 102 is referred to as a ‘P’ operation. The block most highly correlated with a target block is a block having the smallest image difference from the target block. The image difference of two image blocks is defined, for example, as the sum or average of pixel-to-pixel differences of the two image blocks. The block having the smallest image difference is referred to as a reference block. One reference block may be present in each of the reference frames and thus a plurality of reference blocks may be present for each target macroblock.

For example, if two reference blocks of the target macroblock MB40 are found in the prior and subsequent frames and thus the target macroblock MB40 is assigned a bidirectional (Bid) mode as shown in FIG. 4a, the estimator/predictor 102 derives two motion vectors mv0 and mv1 originating from the target macroblock MB40 and extending to the two reference blocks using a motion vector mvBL0, which spans a time interval Tw_{K} including the current frame F40, from among motion vectors of a corresponding block MB4 in a predictive frame F4 in the base layer temporally closest to the current frame F40. The corresponding block MB4 is a block in the predictive frame F4 which would have an area EB4 covering a block having the same size as the target macroblock MB40 if the predictive frame F4 were enlarged to the same size of the enhanced layer frame.

Each motion vector of the base layer is determined by the base layer encoder 150, and the motion vector is carried in a header of each macroblock and a frame rate is carried in a GOP header. The BL decoder 105 extracts necessary encoding information, which includes a frame time, a frame size, and a block mode and motion vector of each macroblock, from the header, without decoding the encoded video data, and provides the extracted information to the estimator/predictor 102.

The estimator/predictor 102 receives the motion vector mvBL0 of the corresponding block MB4 from the BL decoder 105, and scales up the received motion vector mvBL0 by half of the ratio of the screen size of enhanced layer frames to the screen size of base layer frames (i.e., spatially adjusts the size of the received motion vector mvBL0 by multiplying the x and y components thereof by the frame width and height ratios), and calculates derivative vectors mv0′ and mv1′ corresponding to motion vectors (for example, mv0 and mv1) determined for the target macroblock MB40 by Equations (1a) and (1b) or by Equations (2a) and (2b).
mv0′=mvScaledBL0×T_{DO}/(T_{DO}+T_{D1}) (1a)
mv1′=−mvScaledBL0+mv0 (1b)
mv1′=−mvScaledBL0×T_{D1}/(T_{DO}+T_{D1}) (2a)
mv0′=mvScaledBL0+mv1 (2b)

Here, “T_{D1}” and “T_{D0}” denote time differences between the current frame F40 and two base layer frames (i.e., the predictive frame F4 temporally closest to the current frame F40 and a reference frame F4a of the predictive frame F4).

Equations (1a) and (2a) obtain two sections mv0′ and mv1′ of the scaled motion vector mvScaledBL0 which are respectively proportional to the two time difference ratios (k_{T}_{_{—}}_{SCAL}_{_{—}}ᵢ=T_{Di}/(T_{D0}+T_{D1}) (i=0, 1)) of the time differences T_{D0} and T_{D1} between the current frame F40 and the two reference frames (or reference blocks) in the enhanced layer to the time difference (T_{D0}+T_{D1}) between the two reference frames. If a target vector to be derived (“mv1” in the example of FIG. 4a) and the scaled motion vector mvScaledBL0 of the corresponding block are in opposite directions, the estimator/predictor 102 obtains a derivative vector mv1′ using the scaled motion vector mvScaledBL0 after adding a negative sign (−) to the vector mvScaledBL0 (i.e., after multiplying the vector mvScaledBL0 by −1). Both the encoding and decoding apparatuses prescribe whether to use Equations (1a) and (1b) or Equations (2a) and (2b) and whether to derive the forward vector mv0 or the backward vector mv1 from the scaled vector mvScaledBL0 and the time difference ratio k_{T}_{_{—}}_{SCAL}_{_{—}}ᵢ.

If the derivative vectors mv0′ and mv1′ obtained in this manner are identical to the actual motion vectors mv0 and mv1 which have been directly determined, the estimator/predictor 102 merely records information indicating that the motion vectors of the target macroblock MB40 are identical to the derivative vectors, in the header of the target macroblock MB40, without transferring the actual motion vectors mv0 and mv1 to the motion coding unit 120. That is, the motion vectors of the target macroblock MB40 are not coded in this case.

If the derivative vectors mv0′ and mv1′ are different from the actual motion vectors mv0 and mv1 and if coding of the difference vectors mvd0 (=mv0−mv0′) and mvd1 (=mv1−mv1′) between the actual vectors and the derivative vectors is advantageous over coding of the actual vectors mv0 and mv1 in terms of, for example, the amount of data, the estimator/predictor 102 transfers the difference vectors to the motion coding unit 120 so that the difference vectors are coded by the motion coding unit 120, and records information, which indicates that the difference vectors between the actual vectors and the vectors derived from the base layer are coded, in the header of the target macroblock MB40. If coding of the difference vectors mv0−mv0′ and mv1−mv1′ is disadvantageous, the actual vectors mv0 and mv1, which have been previously obtained, are coded.

Only one of the two frames F4 and F4a in the base layer temporally closest to the current frame F40 is a predictive frame. This indicates that there is no need to carry information indicating which one of the two neighbor frames in the base layer has the motion vectors used to encode motion vectors of the current frame F40 since a base layer decoder can specify the predictive frame in the base layer when performing decoding. Accordingly, the information indicating which base layer frame has been used is not encoded when the value indicating derivation from motion vectors in the base layer is recorded and carried in the header.

In the example of FIG. 4b, a frame (Frame B) F40 is a current frame to be encoded into a predictive image, and a base layer frame (Frame A) is a coded predictive frame in a frame sequence of the base layer. In this example, the direction of a scaled motion vector mvScaledBL1 of a corresponding block MB4, which is to be used to derive motion vectors of a target macroblock MB40, is opposite to that of the example of FIG. 4a. Accordingly, Equations (1a) and (1b) or Equations (2a) and (2b) used to derive the motion vectors in the example of FIG. 4a are replaced with Equations (3a) and (3b) or Equations (4a) and (4b).
mv0′=−mvScaledBL1×T_{DO}/(T_{DO}+T_{D1}) (3a)
mv1′=mvScaledBL1+mv0 (3b)
mv1′=mvScaledBL1×T_{D1}/(T_{DO}+T_{D1}) (4b)
mv0′=−mvScaledBL1+mv1 (4b)

Meanwhile, the corresponding block MB4 in the predictive frame F4 in the base layer, which is temporally closest to the current frame F40 to be coded into a predictive image, may have a unidirectional (Fwd or Bwd) mode rather than the bidirectional (Bid) mode. If the corresponding block MB4 has a unidirectional mode, the corresponding block MB4 may have a motion vector that spans a time interval other than the time interval Tw_{K} between adjacent frames (Frame A and Frame C) prior to and subsequent to the current frame F40. For example, if the corresponding block MB4 in the base layer has a backward (Bwd) mode in the example of FIG. 4a, the corresponding block MB4 may have a vector that spans only the next time interval Tw_{K+1}. Also in this case, Equations (1a) and (1b) or Equations (2a) and (2b) may be used to derive motion vectors of the target macroblock MB40 in the current frame F40. Specifically, when “mvBLb” denotes a vector of the corresponding block MB4, which spans the next time interval TW_{K+1}, and “mvScaledBLb” denotes a scaled vector of the vector mvBLb, “−mvScaledBLb” is substituted for “mvScaledBLb” to obtain target derivative vectors mv0′ and mv1′ as in Equations (1b) and (2a) if the target derivative vectors mv0′ and mv1′ and the scaled vector mvScaledBLb are in opposite directions.

Similarly, if the corresponding block MB4 in the frame (Frame A) in the base layer has a forward (Fwd) mode rather than the bidirectional mode in the example of FIG. 4b, the target derivative vectors can be obtained by substituting a scaled vector of the motion vector of the corresponding block MB4 into Equations (1a) and (1b) or Equations (2a) and (2b) after adding a positive or negative sign (+) or (−) to the scaled vector (i.e., after multiplying the scaled vector by +1 or −1) depending on whether the scaled vector and the target derivative vectors are in the same or opposite directions.

Thus, even if the corresponding block in the base layer has no motion vector in the same time interval as the time interval between the adjacent frames prior to and subsequent to the current frame in the enhanced layer, motion vectors for the current macroblock MB40 can be derived using the motion vector of the corresponding block.

A data stream including L and H frames encoded in the method described above is transmitted by wire or wirelessly to a decoding apparatus or is delivered via recording media. The decoding apparatus reconstructs the original video signal in the enhanced and/or base layer according to the method described below.

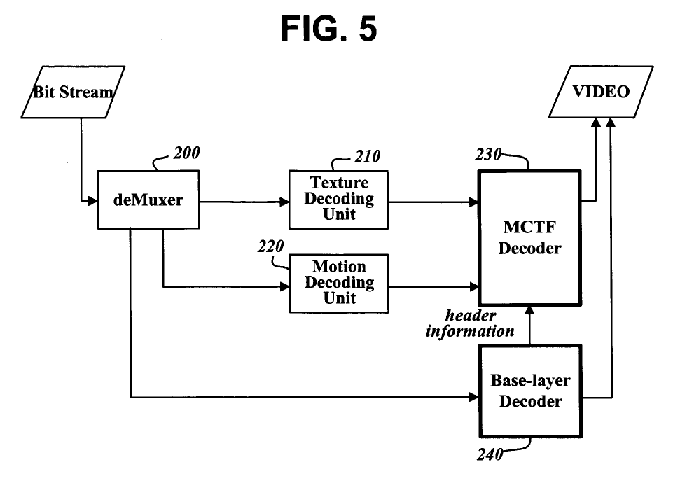

FIG. 5 is a block diagram of an apparatus for decoding a data stream encoded by the apparatus of FIG. 2. The decoding apparatus of FIG. 5 includes a demuxer (or demultiplexer) 200, a texture decoding unit 210, a motion decoding unit 220, an MCTF decoder 230, and a base layer decoder 240. The demuxer 200 separates a received data stream into a compressed motion vector stream, a compressed macroblock information stream, and a base layer stream. The texture decoding unit 210 reconstructs the compressed macroblock information stream into its original uncompressed state. The motion decoding unit 220 reconstructs the compressed motion vector stream into its original uncompressed state. The MCTF decoder 230 converts the uncompressed macroblock information stream and the uncompressed motion vector stream back to an original video signal according to an MCTF scheme. The base layer decoder 240 decodes the base layer stream according to a specified scheme, for example, according to the MPEG-4 or H.264 standard. The base layer decoder 240 not only decodes an input base layer stream but also provides header information in the stream to the MCTF decoder 230 to allow the MCTF decoder 230 to use necessary encoding information of the base layer, for example, information regarding the motion vector.

The MCTF decoder 230 includes a structure for reconstructing an input stream to an original frame sequence.

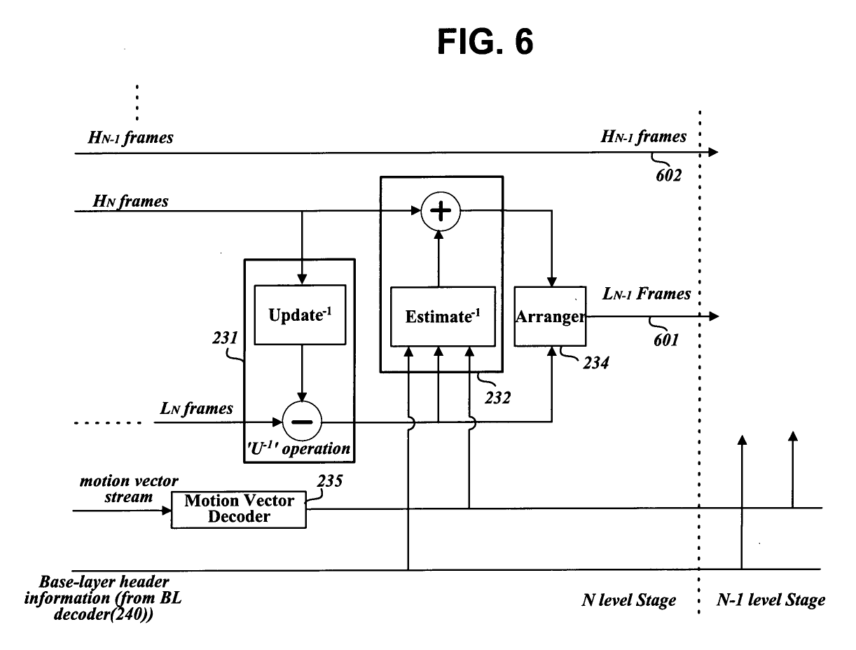

FIG. 6 illustrates such an internal structure of the MCTF decoder 230, which is responsible for reconstructing a sequence of H and L frames of MCTF level N into an L frame sequence of MCTF level N-1. The internal structure shown in FIG. 6 includes an inverse updater 231, an inverse predictor 232, a motion vector decoder 235, and an arranger 234. The inverse updater 231 subtracts pixel difference values of input H frames from corresponding pixel values of input L frames. The inverse predictor 232 reconstructs input H frames into L frames having original images using the H frames and the L frames, from which the image differences of the H frames have been subtracted. The motion vector decoder 235 decodes an input motion vector stream into motion vector information of macroblocks in H frames and provides the motion vector information to an inverse predictor (for example, the inverse predictor 232) of each stage. The arranger 234 interleaves the L frames completed by the inverse predictor 232 between the L frames output from the inverse updater 231, thereby producing a normal sequence of L frames.

L frames output from the arranger 234 constitute an L frame sequence 601 of level N-1. A next-stage inverse updater and predictor of level N-1 reconstructs the L frame sequence 601 and an input H frame sequence 602 of level N-1 into an L frame sequence. This decoding process is performed the same number of times as the number of MCTF levels employed in the encoding procedure, thereby reconstructing an original video frame sequence.

A more detailed description will now be given of how H frames of level N are reconstructed into L frames according to the present invention. First, for an input L frame, the inverse updater 231 subtracts error values (i.e., image differences) of macroblocks in all H frames, whose image differences have been obtained using blocks in the L frame as reference blocks, from the blocks of the L frame.

For each target macroblock of a current H frame, the inverse predictor 232 checks information regarding the motion vector of the target macroblock. If the information indicates that the motion vector of the target macroblock is identical to a derivative vector from the base layer, the inverse predictor 232 obtains a scaled motion vector mvScaledBL from a motion vector mvBL of a corresponding block in a predictive image frame (for example, an H frame), which is one of the two base layer frames temporally adjacent to the current H frame, provided from the BL decoder 240 by scaling up the motion vector mvBL by half of the ratio (i.e., by the resolution ratio) of the screen size of enhanced layer frames to the screen size of base layer frames. The inverse predictor 232 then derives the actual vectors (mv0=mv0′ and mv1=mv1′) according to Equations (1a) and (1b) or Equations (2a) and (2b) (when using the forward vector of the corresponding block) or according to Equations (3a) and (3b) or Equations (4a) and (4b) (when using the backward vector of the corresponding block).

If the information regarding the motion vector indicates that a difference vector from a derivative vector has been coded, the inverse predictor 232 first obtains a derivative vector mv0′ (or mv1′) by Equation (1a) (or (2a)) (when using the forward vector of the corresponding block) or by Equation (3a) (or (4a)) (when using the backward vector of the corresponding block), and adds a difference vector mvd0 (or mvd1) of the target macroblock corresponding to the obtained derivative vector mv0′ (or mv1′), which is provided from the motion vector decoder 235, to the derivative vector mv0′ (or mv1′), thereby obtaining an actual motion vector mv0=mv0′+mvd0 (or mv1=mv1′+mvd1) of the target macroblock. Then, the other actual vector mv1 (or mv0) is obtained by substituting the obtained actual vector, i.e., the forward (or backward) vector mv0 (or mv1), into Equation (1b) (or (2b)) (when using the forward vector of the corresponding block) or into Equation (3b) (or (4b)) (when using the backward vector of the corresponding block).

The inverse predictor 232 determines a reference block, present in an adjacent L frame, of the target macroblock of the current H frame with reference to the actual vector derived from the base layer motion vector or with reference to the directly coded actual motion vector, and reconstructs an original image of the target macroblock by adding pixel values of the reference block to difference values of pixels of the target macroblock. Such a procedure is performed for all macroblocks in the current H frame to reconstruct the current H frame into an L frame. The arranger 234 alternately arranges L frames reconstructed by the inverse predictor 232 and L frames updated by the inverse updater 231, and provides such arranged L frames to the next stage.

According to the above decoding method, an MCTF-encoded data stream is reconstructed into a complete video frame sequence. Alternatively, a video frame sequence with a lower image quality and at a lower bitrate may be obtained by performing the inverse update and prediction procedures a smaller number of times than the number of temporal decomposition levels employed in the MCTF encoding procedure.

The decoding apparatus described above can be incorporated into a mobile communication terminal, a media player, or the like.

As is apparent from the above description, a method and apparatus for encoding/decoding video signals according to the present invention has the following advantages. During MCTF encoding, motion vectors of macroblocks of the enhanced layer are coded using motion vectors of the base layer provided for low performance decoders, thereby eliminating redundancy between motion vectors of temporally adjacent frames. This reduces the amount of coded motion vector data, thereby increasing the MCTF coding efficiency.

Although this invention has been described with reference to the preferred embodiments, it will be apparent to those skilled in the art that various improvements, modifications, replacements, and additions can be made in the invention without departing from the scope and spirit of the invention. Thus, it is intended that the invention cover the improvements, modifications, replacements, and additions of the invention, provided they come within the scope of the appended claims and their equivalents.

What is claimed is:

1. An apparatus for encoding an input video signal, the apparatus comprising:
a first encoder for encoding the video signal in a first scheme and outputting a bitstream of a first layer; and
a second encoder for encoding the video signal in a second scheme and outputting a bitstream of a second layer including frames having a smaller screen size than frames in the bitstream of the first layer,
the first encoder including means for obtaining a first derivative vector corresponding to a first motion vector, obtained through motion estimation, of an image block included in an arbitrary frame in the video signal based on the product of a derivation factor and a scaled motion vector obtained by scaling a motion vector of a first block included in a frame of the second layer not temporally coincident with the arbitrary frame by half of the ratio of a frame size of the first layer to a frame size of the second layer, obtaining a second derivative vector corresponding to a second motion vector, obtained through motion estimation, of the image block based on both the scaled motion vector and the first motion vector, and recording, in the bitstream of the first layer, information allowing the motion vectors of the image block to be obtained from the first and second derivative vectors.

2. The apparatus according to claim 1, wherein the first block is present at a position corresponding to the image block in a frame of the second layer temporally separated from the arbitrary frame.

3. The apparatus according to claim 2, wherein the frame including the first block is a predictive image frame having image difference data and being temporally closest to the arbitrary frame from among frames in a frame sequence in the second layer.

4. The apparatus according to claim 1, wherein the arbitrary frame has no temporally coincident frame in a frame sequence included in the bitstream of the second layer.

5. The apparatus according to claim 1, wherein the information recorded in the bitstream of the first layer indicates that the motion vectors of the image block are identical to the first and second derivative vectors.

6. The apparatus according to claim 1, wherein the information recorded in the bitstream of the first layer includes information of respective difference vectors between the first and second motion vectors of the image block and the first and second derivative vectors.

7. The apparatus according to claim 1, wherein the derivation factor is the ratio of a time interval between the arbitrary frame and a frame, present downstream of the arbitrary frame in a target derivative vector direction of the image block, to a time interval between the frame including the first block and another frame including a block pointed to by the motion vector of the first block.

8. The apparatus according to claim 1, wherein the first derivative vector is obtained by multiplying the derivation factor by the scaled motion vector multiplied by a first value, and the second derivative vector is obtained by adding the first motion vector to the scaled motion vector multiplied by a second value, wherein the first value and the second value are either +1 and −1 or −1 and +1.

9. The apparatus according to claim 8, wherein the first value is +1 if the scaled motion vector has a similar direction to a target derivative vector direction of the first derivative vector, and −1 if the scaled motion vector has a different direction from the target derivative vector direction thereof.

10. An apparatus for receiving and decoding a bitstream of a first layer including frames, each including pixels having difference values, into a video signal, the apparatus comprising:
a first decoder for decoding the bitstream of the first layer in a first scheme into video frames having original images; and
a second decoder for receiving a bitstream of a second layer including frames having a smaller screen size than the video frames, extracting encoding information including motion vector information from the received bitstream of the second layer, and providing the encoding information to the first decoder,
the first decoder including means for obtaining a first motion vector of a target block included in an arbitrary frame in the bitstream of the first layer from a first derivative vector obtained based on the product of a derivation factor and a scaled motion vector obtained by scaling a motion vector, included in the encoding information, of a first block included in a frame of the second layer not temporally coincident with the arbitrary frame by half of the ratio of a frame size of the first layer to a frame size of the second layer, and obtaining a second motion vector of the target block from a second derivative vector obtained based on both the scaled motion vector and the obtained first motion vector.

11. The apparatus according to claim 10, wherein the means uses the first and second derivative vectors as bidirectional motion vectors of the target block if information regarding the target block, included in the bitstream of the first layer, indicates that the first and second derivative vectors are identical to the motion vectors of the target block.

12. The apparatus according to claim 10, wherein the means obtains the first and second motion vectors of the target block by calculation using the first and second derivative vectors and corresponding difference vectors if information regarding the target block, included in the bitstream of the first layer, indicates inclusion of information of the difference vectors.

13. The apparatus according to claim 10, wherein the derivation factor is the ratio of a time interval between the arbitrary frame and a frame, present downstream of the arbitrary frame in a target derivative vector direction of the target block, to a time interval between the frame including the first block and another frame including a block pointed to by the motion vector of the first block.

14. The apparatus according to claim 10, wherein the first derivative vector is obtained by multiplying the derivation factor by the scaled motion vector multiplied by a first value, and the second derivative vector is obtained by adding the first motion vector to the scaled motion vector multiplied by a second value, wherein the first value and the second value are either +1 and −1 or −1 and +1.

15. The apparatus according to claim 14, wherein the first value is +1 if the scaled motion vector has a similar direction to a target derivative vector direction of the first derivative vector, and −1 if the scaled motion vector has a different direction from the target derivative vector direction thereof.

16. A method for receiving and decoding a bitstream of a first layer including frames, each including pixels having difference values, into a video signal, the method comprising:
decoding the bitstream of the first layer into video frames having original images according to a scalable scheme using encoding information including motion vector information, the encoding information being extracted and provided from an input bitstream of a second layer including frames having a smaller screen size than frames in the first layer,
decoding the bitstream of the first layer into the video frames including a process for obtaining a first motion vector of a target block included in an arbitrary frame in the bitstream of the first layer from a first derivative vector obtained based on the product of a derivation factor and a scaled motion vector obtained by scaling a motion vector, included in the encoding information, of a first block included in a frame of the second layer not temporally coincident with the arbitrary frame by half of the ratio of a frame size of the first layer to a frame size of the second layer, and obtaining a second motion vector of the target block from a second derivative vector obtained based on both the scaled motion vector and the obtained first motion vector.

17. The method according to claim 16, wherein the process includes using bidirectional derivative vectors as the first and second motion vectors of the target block if information regarding the target block, included in the bitstream of the first layer, indicates that the first and second derivative vectors are identical to the motion vectors of the target block.

18. The method according to claim 16, wherein the process includes obtaining the first and second motion vectors of the target block by calculation using the first and second derivative vectors and corresponding difference vectors if information regarding the target block, included in the bitstream of the first layer, indicates inclusion of information of the difference vectors.

19. The method according to claim 16, wherein the derivation factor is the ratio of a time interval between the arbitrary frame and a frame, present downstream of the arbitrary frame in a target derivative vector direction of the target block, to a time interval between the frame including the first block and another frame including a block pointed to by the motion vector of the first block.

20. The method according to claim 16, wherein the first derivative vector is obtained by multiplying the derivation factor by the scaled motion vector multiplied by a first value, and the second derivative vector is obtained by adding the first motion vector to the scaled motion vector multiplied by a second value, wherein the first value and the second value are either +1 and −1 or −1 and +1.

21. The method according to claim 20, wherein the first value is +1 if the scaled motion vector has a similar direction to a target derivative vector direction of the first derivative vector, and −1 if the scaled motion vector has a different direction from the target derivative vector direction thereof.
